(19) United States
(12) Patent Application Publication
(10) Pub. No.: US 2003/0187771 A1
(43) Pub. Date: Oct. 2, 2003

(54) Investment management system

(76) Inventor: James Bulan, Chesterfield, MO (US)

Correspondence Address: BURDICK LAW FIRM, 3656 Western Ave., Alton, IL, 62002, US

(21) Appl. No.: 10/112,288

(22) Filed: Mar. 30, 2002

(51) Int. Cl. G06F 17/60

(52) U.S. Cl. 705/36

(57) ABSTRACT

An investment management and optimization system which redistributes cash based on buying and selling criteria derived from a statistical confidence levels and recommends timing, quantity and selection of investment buys and sells from a portfolio of investments, such as stocks

### BACKGROUND OF THE INVENTION

The invention relates to securities management programs and particularly to ones with combined cash management.

Buy low, sell high. Money won, money lost. This is the great game, profession and passion of stock investing. Millions of people do it every day and billions of dollars worth of securities change hands with both buyer and seller hoping to profit. Traders hope for a magic formula to make money in stocks. Fundamental analysis of stocks has been tried using averaging of lows and highs, upward or downward trends, cost averaging. Pundits sometimes win and sometimes lose. Is there a reliable winning stock program we could all choose? We think there is and we think it is described below.

Stock investment programs are desirable to investors if they produce recommendations that result m higher profit than investors can achieve through other investment advice available to the investors at reasonable cost. Investors sometimes rely on emotional factors. Investors sometimes are inattentive to daily changes in one or more stocks in their portfolio and thus may miss a key opportunity on one of their stocks. Investors are not always very expert in stock selections and may have faulty memory of historical stock prices. Investors only process a limited amount of data on their own, particularly m the limited time available to them for investment purposes, particularly where investing is not the investor's primary job. Computers on the other hand can process mathematically an incredible amount of data and can remember that information indefinitely. It would therefore be desirable to have a computer program to assist in better managing stocks to take financial advantage of price fluctuations.

### BRIEF SUMMARY OF THE INVENTION

In an exemplary embodiment a computer program is operable on a personal computer, such as one having a Windows operating system. The program statistically evaluates price of a stock over a selected length of time and develops a rating based on a statistical probability that the stock price is near a high or near a low or somewhere between. If the stock price is below a statistically derived buy price threshold and above a historical low, a buy signal is generated. Conversely, if the stock is above a statistically derived sell price threshold and below a historical high, a sell signal is generated. The exemplary program also redistributes cash among the various stocks based on the strength of performance. The program uses a cash reserve that is redistributed each time the program is run. Returns on investment of 20% and above have been typically achieved.

Numerous other exemplary embodiments and alternatives of the invention are also discussed with the understanding that other equivalents are also included.

### BRIEF DESCRIPTION OF THE DRAWINGS

The invention will be better understood by reference to the attached drawing of an exemplary stock program which drawing includes:

FIG. 1 is a flow diagram of a registration sequence of an exemplary stock management program.

FIG. 2 is a flow diagram of a log on sequence of the stock management program of FIG. 1,

FIG. 3 is a flow diagram of a new stock entry sequence of the exemplary stock management program of FIG. 1,

FIG. 4 is a flow diagram of a stock deletion sequence of the exemplary stock management program of FIG. 1,

FIG. 5 is a flow diagram of a stock selection sequence of the exemplary stock management program of FIG. 1,

FIG. 6 is a flow diagram of a current price sequence of the exemplary stock management program of FIG. 1,

FIG. 7 is a flow diagram of a price refreshing sequence of the exemplary stock management program of FIG. 1,

FIG. 8 is a flow diagram of a price deletion sequence of the exemplary stock management program of FIG. 1,

FIG. 9 is a flow diagram of a buy/sell sequence of the exemplary stock management program of FIG. 1,

FIG. 10 is a flow diagram of a cash deposit/withdraw sequence of the exemplary stock management program of FIG. 1,

FIG. 11 is a flow diagram of a trading range viewing sequence of the exemplary stock management program of FIG. 1,

FIG. 12 is a flow diagram showing the transaction history viewing, exporting or Resetting sequence of the program of FIG. 1,

FIG. 13 is a flow diagram showing he overall relationship of the objects in the exemplary stock management program of FIG. 1,

FIG. 14 is a flow diagram of an exemplary planner program that can be used in association with the program of FIG. 1, and

FIG. 15 is a flow diagram of an exemplary evaluator program that can be used in association with the stock management program of FIG. 1 and with the planner program of FIG. 14.

### DETAILED DESCRIPTION OF THE INVENTION

FIG. 1 is a flow diagram of an exemplary registration sequence 101 of an exemplary stock management program 100 that is disclosed for purposes of enablement and best mode disclosure. It will be understood that program 100 and sequence 101 are exemplary and not exclusive. The interfaces could be modified to more aesthetically appealing and portions in one object might be placed in other objects. Program 100 and the sequences shown in the figures could be tailored to fit different platforms and windows and buttons could be moved, modified and combined. The claims and the prior art alone limit the scope of the invention disclosed, not anything in this exemplary disclosure, unless expressly made limiting in unequivocal language. The absence of the word “exemplary” in any reference is not intended to imply a limitation strictly to the embodiment shown, unless the words expressly state a limitation. Just because we disclose a preferred or best mode does not mean that is the only mode. Also, we do not intentionally disclaim or dedicate to the public anything disclosed in this application, but intend the claims to be interpreted to cover everything that is disclosed in this application that could be claimed over the prior art and any omission to claim something is strictly unintentional.

Exemplary registration sequence 101 utilizes portions of program 100 resident in a memory 109 of a computer 108. Sequence 101 comprises a manager object 102, a user logon dialog 103, a registration dialog 118, a new portfolio object 104, a verification file 105, and anew security object 106. When computer 108 is turned on and program 100 is launched, manager object 102 sends a command 114 to computer 108 to display, as indicated by arrow 116, user dialog 118 on a display screen 115. Registration is accomplished by inputting, as indicated by arrow 110, a date into a date window 122 and a ten-character security code for the day into a code window 131 of dialog 103 using a keyboard 107 or a mouse 112 of computer 108. The security code is passed, as indicated by arrow 117 to new security object 106 which is created upon launch of the program if no security object has been previously created. Object 106 verifies the security code entered in window 131 and upon success creates a verification file 105, as indicated by arrow 113. Security object 106 then commands, as indicated by arrow 117, dialog 118 to close and a logon dialog 103 to open with an ID window 129 and password window 130. The user then enters, in similar fashion to arrow 110 a user ID and Password into windows 129 and 130, respectively, using keyboard 107 or mouse 119. Dialog 103 sends the ID and password thus entered to security object 106. Security object 106 responds to a successful ID and password combination by creating, as indicated by arrow 120, a new portfolio object 104, for the user, that contains information particular to that user, such as a plurality of stock objects described below and by opening a link 121 between object 104 and manager object 102 so the substantive parts of program 100 can be run. Portfolio object 104 signals, through link 121, manager object 102 that the registration sequence is complete. Manager object 102 responds to that completion signal by sending a command 114 to computer 108 to display a manager dialog (described below) on screen 115 to begin the substantive operation of manager 102.

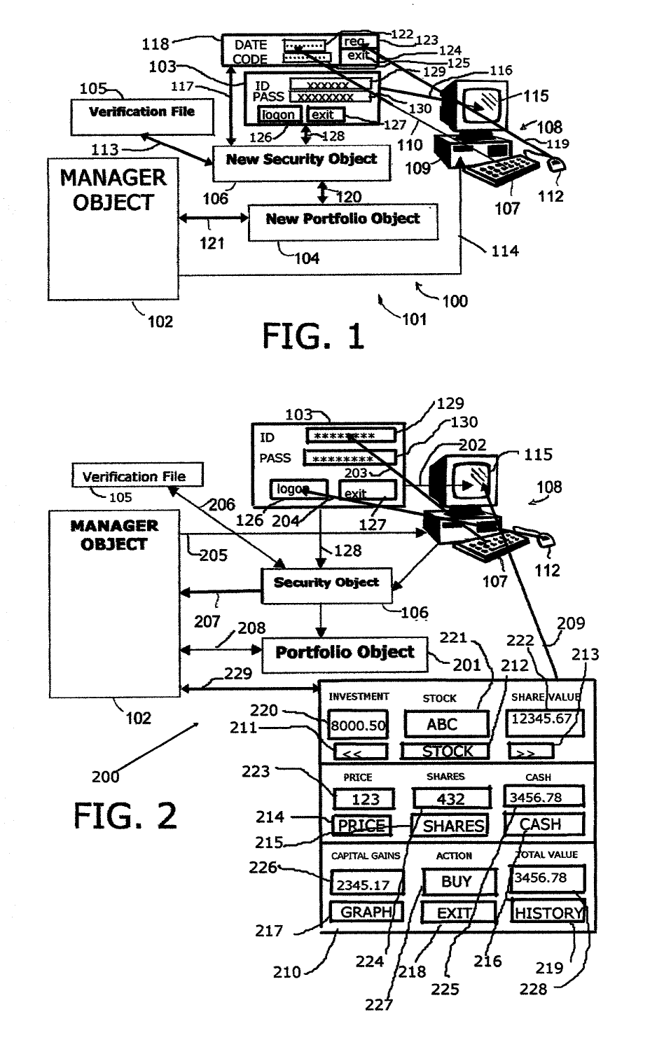

FIG. 2 is a flow diagram of an exemplary logon sequence 200 of program 100, and shows the exemplary manager dialog window 210 that appears following successful logon as noted above. Sequence 200 is for users who have previously registered using sequence 101 and is thus an alternative to sequence 101 once registration has occurred. Since a registered user already has a security object 106, a verification file 105 and a portfolio object 201, dialog 118 does not appear, but rather program 100 skips to logon dialog 103. The user merely enters, as indicated by arrow 203, the user's ID and Password into windows 129 and 130, as previously noted, using keyboard 107 or mouse 112. Security object 106 checks, as indicated by arrow 206, verification file 105 for the D and Password entered. Upon successful verification object 106 notifies, as indicated by arrow 207, manager object 102 to open a link 208 with portfolio object 201 and to display, as indicated by arrows 229 and 209, a manager dialog 210 on screen 115 to allow substantive operation of manager 102. Manager dialog 210 has nine buttons, back button 211, stock button 212, forward button 213, price button 214, shares button 215, cash button 216, graphic button 217, an exit button 218 and a history button 219 each labeled accordingly. Manager dialog 210 also has nine informational windows: investment window 220, stock window 221, share value window 222, price window 223, shares window 224, cash window 225, capital gains window 226, advice window 227, and total value window 228. The function of these exemplary buttons and windows will be described below. There are numerous different graphic user interface arrangements that could be used instead, but this exemplary one is simple and straightforward and thus preferred.

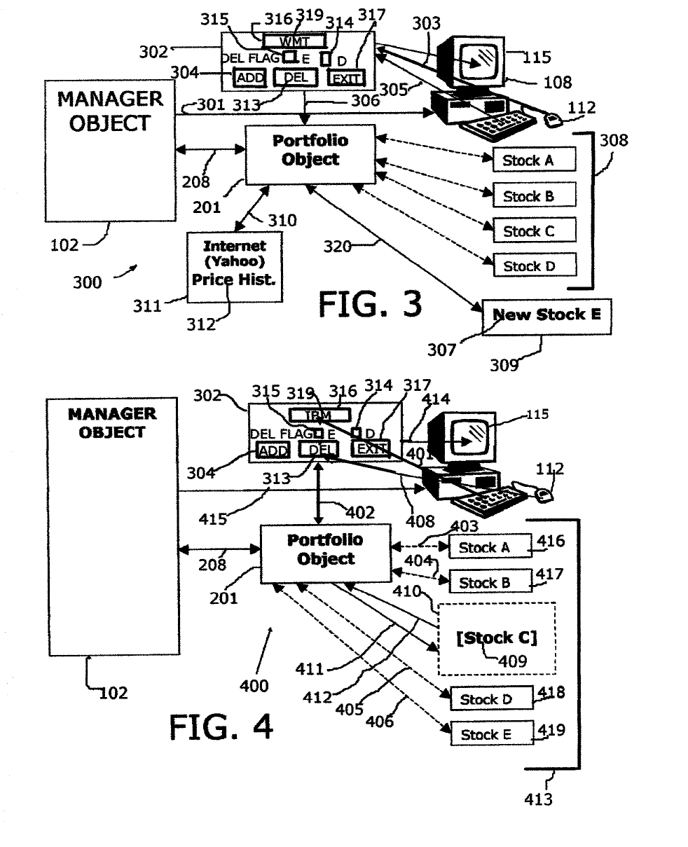

FIG. 3 is a flow diagram of an exemplary stock addition sequence 300 of program 100. Clicking on stock button 212 of dialog 210 commences stock addition sequence 300. Clicking on stock button 212 with mouse 112 causes manager object 102 to send a signal 301 to screen 115 to display a stock dialog 302. Link 207 between manager 102 and portfolio object 201 was already established in logon sequence 200. Dialog 302 comprises a window 316 for display of a stock symbol 319, a delete flag enable button 315, a delete flag disable button 314, an add button 304, a delete button 313 and an exit button 317. Symbol 319 for a default stock object 309 appears in a window 316. The user then enters, as indicated by arrow 305, a stock symbol 319 of a different stock to be added and then clicks on an add button 304 in dialog 302 with mouse 112 to send an add signal 303 to dialog 302. Dialog 302 responds to signal 303 by initiating addition, as indicated by arrow 306, of a new stock object 309 for the stock symbol to portfolio 201. Before creating object 309, portfolio object 201 checks to determine if stock object 309 corresponding to the stock 307 is already in a portfolio 308 of stock objects in object 201. If object 309 is already in portfolio 308 then object 201 returns an error indication and does not add a second object 309. Upon determining that stock 307 is not in portfolio 308, a new stock object 309 is created and a link 318, 320 is established between manager object 102 and object 309. Portfolio object 201 then obtains, as indicated by arrow 310, a price history 312 for stock 307 from an Internet information source 311 such as Yahoo! Finance's stock price history database, a price history 312 and records history 312 in stock object 309 for future reference. An initialization analysis is run.

The initialization analysis is conducted as follows Once array 318 is updated, object 309 performs an initialization during which the Mean (“M”) and Standard Deviation (“SD”) of the prices in array 318 for a given stock are calculated in conventional statistical manner and stored. From M and SD, a Buy Threshold (“BT”) is calculated and stored. The Buy Threshold is equal to the Mean less the product of SD and the Z-Score of the Confidence Level (“Z”). Thus BT can be expressed as BT=M−(SD*Z). From M and SD, a Sell Threshold (“ST”) is also calculated and stored. The Sell Threshold value is equal to the Mean less the product of SD and the Z-Score of the Confidence Level (“Z”). Thus ST=M+(SD*Z). Object 309 then checks array 318 for the last 90 days of daily prices for stock 307 and determines and records a 90 day high (“90H” or “NDH”) value and a 90 day low (“90L” or “NDL”) value. A Last Buy (“LB”) value is set as the price of the last buy transaction or zero if none. Last Sell (“LS”) value is set as the price of the last sell transaction or zero if none. First Buy (“FB”) is set as the first buy price since the last sell, or zero if none. First Sell (“FS”) is set as the first sell price since the last buy (or zero if none). Buy Ratio (“BR”) and Sell Ration (“SR”) starts at 0.15 for a first consecutive transaction, and will be increased by 0.15 for each consecutive day of buy or sell signals, respectively, until max of 0.90. A maximum of 0.90 is present to assure that there is always at least 10% of the cash left for the next day's redistribution. The BR and SR are stored. The standard Brokerage Fee (“BF”) is obtained and stored.

Once initialization of object 309 is completed, a Buy Signal (“BS”) generation process and a Sell Signal (“SS”) generation process occur in the following steps: a first step in which the data for the stock is queried to see if the Current Price (“CP”) is less than BT. If not, the price is considered too high and BS is set at zero If yes, in a second step object 309 again queries array 318 to see if 90L<CP<LB or if LB=0. If not, the price in window 223 is considered too high and BS is set at zero, indicating absence of a “Buy” recommendation. If yes, the Cash Available (“CA”) in Cash Memory for stock X is requested, as indicated in box 510 and the BR for stock X is requested, and BS is set at one, as indicated by box 509, indicating presence of a “Buy” recommendation.

Once the Buy Signal (“BS”) is set at zero or one, an exemplary Sell Signal (“SS”) generation process occurs in the following three steps: a first step in which the data for stock X is queried to see if the Current Price (“CP”) 230 is more than ST. If not, the price 230 is considered too low to sell and SS is set at zero. If yes, in a second step, analyzer 304 again checks the data to see if LS<CP<90H or if LS=0. If not, price 230 is considered too high and BS is set at zero, indicating absence of a “Sell” recommendation. If yes, the Shares Available value (“SA”) in object 309 for stock 307 are requested and the SR for stock 307 is requested, the Recommended Shares value (“RS”) is then set equal to SR×((SA−Fee/CP), and SS is set at one, indicating presence of a “Sell” recommendation, and SS is stored in object 309 for future use.

A cash balance sequence is then run to allocate cash to stock object 309.

The user repeats the addition sequence if another stock object is desired to be added to portfolio 308 or, if done, clicks on exit button 314 to return to dialog 210.

FIG. 4 is a flow diagram of an exemplary stock deletion sequence 400 of program 100. Stock deletion sequence 400 is commenced from dialog 210 in similar fashion to addition sequence 300 except delete button 313 is clicked rather than add button 304. If not already open, the user opens stock dialog 302 by clicking on stock button 212 using mouse 112 as noted above. The user then enters into window 316, or otherwise selects, as described below, symbol 319 of the stock object 409 to be deleted and clicks on delete button 313 with mouse 112 to send a delete signal 408 to manager 102. Manager object 102 then transfers, as indicated by arrow 402, a delete command and information for stock object 409 to portfolio object 201. Object 201 checks to determine if the stock 409 is in the portfolio 413, and returns an error signal if not. If object 201 determines that stock 4 is in portfolio 413, and that stock object 409 has no cash and no shares held, object 410 is deleted. If, however, object 410 is holding cash or shares, object 410 sends a “can't do” signal 412 and deletion is refused and a signal is sent via 208 to manager 102 to cause an informational “delete flag” error signal (not shown) to occur to tell the user that the user must withdraw all cash in object 410 and sell all stock 409 prior to deleting object 410. If object 410 is holding no shares but has cash, the user may click on “delete Flag Disabled” button 314 to disable the delete flag error as to cash and then on delete button 313. Clicking on button 314 while the delete flag is disabled triggers a “cash balance function” described below to remove all cash from object 410. All shares of stock 409 must be sold prior to deletion of object 410, so there is no override as to stock like there is for cash. Once stock and cash are sold and removed, respectively, from object 410 the deletion of object 410 may occur. The deletion operation of FIG. 4, and any further addition operation of FIG. 3, may be repeated at this i. Once deletions and additions are completed, exit button 317 is clicked to return to dialog 210.

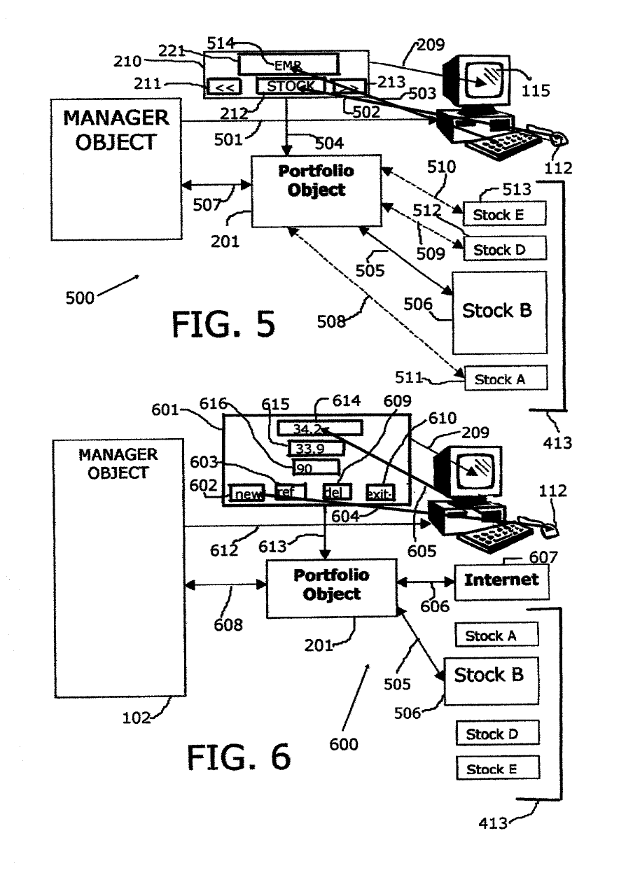

FIG. 5 is a flow diagram of an exemplary stock selection sequence 500 of program 100. In order to perform an operation on an individual stock object 410 in portfolio 413, it is desirable to select one of stock objects 506, 511, 512 or 513 and link to that object so that whatever is done is done just to that stock, unless it is an operation that is to be done on all stocks. Although not specifically shown in the figures, updating price history or obtaining current price might be done on all stock objects at once. Selection of a stock object can be done by either (a) entering the stock symbol 514 into window 21 of manager dialog 210 and clicking on the stock button 212 or (b) by sequencing forward or backward through portfolio 413 using sequence 500. Sequence 500 performs a selection from dialog 210 when the user clicks with mouse 112 on button 211, 212 or 213. Button 211 is a back (or previous or prior) button. Button 213 is a forward (or next) button. Button 213, for example, will produce a signal 504 to portfolio 201 to cause portfolio 201 to unlink, as indicated by dotted arrow 508, from stock object 511 and to link, as indicated by solid arrow 505, to object 506 and to signal through link 507 manager object 102 to signal display 115 to show the user stock B information. Pushing next button 213 again, would cause portfolio 201 to unlink from object 506 and to activate link 509 to stock object 512 and display 115 to show that Stock C information. Pushing next button 404 a third time, would cause portfolio 201 to unlink from object 512 and to link 510 to stock object 513 Pushing back button 211 instead of pushing button 213 the third time, would cause link 509 to go inactive and link 505 to reactivate, thus linking object 506 again to portfolio 201. Pushing button 211 or 213 when one is linked to the last stock object or first stock object would cause object 201 to link with the first or last stock object, respectively, in stock portfolio 413. That is, the next object after the last object is the first object and the previous object to the first object is the last object so that the next button alone or previous button alone can reach all objects. Note that although for simplicity only a portion of dialog 210 is shown in FIG. 5, the entire dialog 210 would be present.

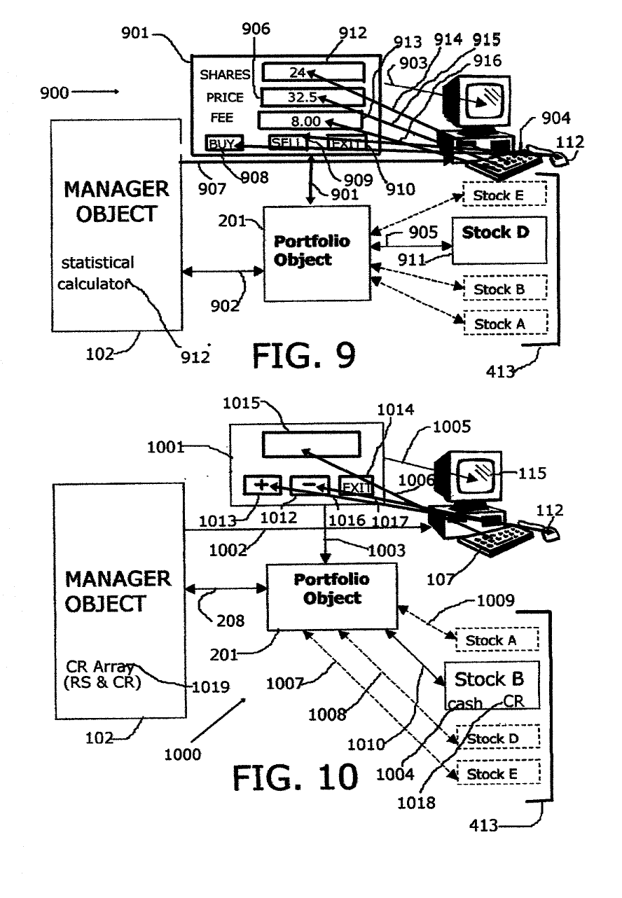

FIG. 6 is a flow diagram of an exemplary current price input sequence 600 of program 100. Sequence 600 is activated by pushing price button 214 of manager dialog 210 to cause manager object 102 to send a command 612 to screen 115 to display price dialog 601. Dialog 601 has four buttons, a new button 602, a refresh button 603, a delete button 609 and an exit button 610. When price button 213 is activated, signal 613 is sent to portfolio object 201 to link, as indicated by arrow 606, to an internet stock price database 607 and obtain the current price for each stock in portfolio 413. Alternatively, the selected stock object 506 could be linked to the internet to obtain a price history for just object 506 or for all objects in portfolio 413. Price dialog 601 might be eliminated if it was desired to simplify by having manager object 102 query the internet database 607 and display the result directly without going to dialog 601. However, the price query is sufficiently fast that even if portfolio has ten or fifteen stocks, there is no significant delay in obtaining ten or fifteen current prices relative to obtaining just one current price. Portfolio object 201 then signals manager object 102 through link 608 to signal, as indicated by arrow 612, computer 108 to display, as indicated by arrow 209, the current price quote 614 for selected stock 514 to display on screen 115. The user can either accept the current price by clicking on exit button 604 to close dialog 601 and return to dialog 210 or can decline to accept by entering, as indicated by arrow 605, a different new price 611 into dialog 601 and clicking, as indicated by arrow 604, on new button 610 with mouse 112. If new button 610 is clicked, dialog 601 passes, as indicated by arrow 603, the new price data to portfolio object 201 and object 201 sends, as indicated by arrow 607, the new price to the appropriate stock object 611 and a buy/sell signal process (see FIG. 9) is executed and a buy/sell signal is passed via link 608 to manager object 102 along with a recommended number of shares. The price history is updated to include the new price and that information is displayed in a price history window 615 of dialog 601 so that the user knows the update has successfully occurred. Alternately, the user can click on refresh button 603 and a new price history will be substituted for the current price history and the result displayed in window 615, as described below. A history period window 616 displays in dialog 601 to allow the user to know and, optionally, to change the price history period for stock object 506. When the update is finished, exit button 502 is pushed to return to manager dialog 210.

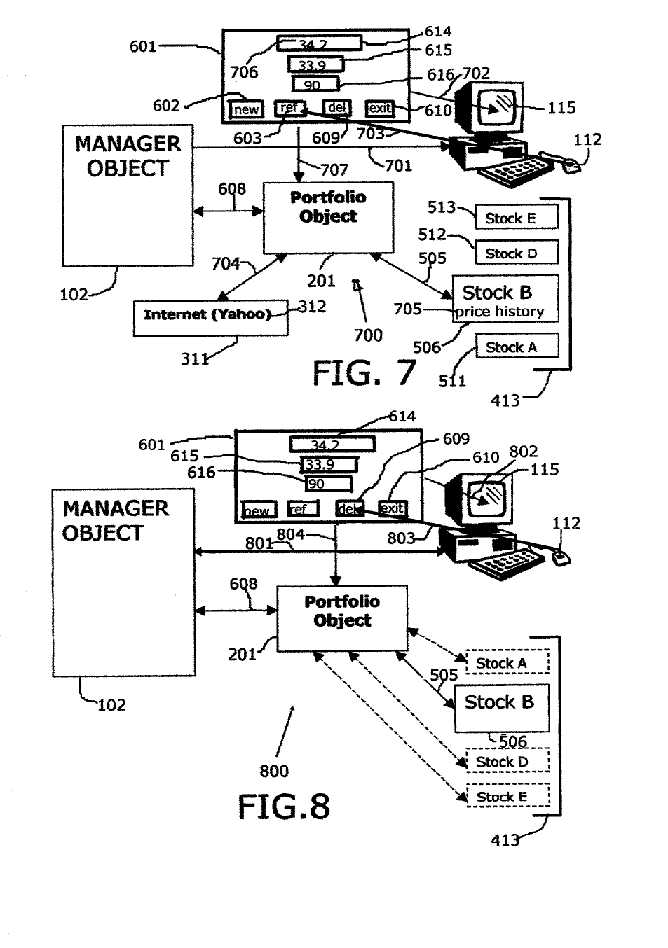

FIG. 7 is a flow diagram of an exemplary price refreshing sequence 700 of program 100. Sequence 701 refreshes the price history for portfolio 413. Sequence 700 is activated when price dialog 701 is displayed, as indicated by arrow 703, on screen 115, by clicking on a refresh button 603 using mouse 112. Clicking button 603 causes dialog 701 to send a refresh signal 709 to portfolio object 201. Object 201 responds to signal 709 by opening a link 704 to an internet stock price database 311 and retrieving price history from database 311. The new price history is displayed in window 615 and a new current price 706 is displayed in window 614. This history is recorded, via link 505, in each stock object in portfolio 413.

FIG. 8 is a flow diagram of an exemplary price deletion sequence 800 of program 100 that is activated from price dialog 701 by clicking on delete button 801 to cause dialog 701 to send a delete signal 807 to portfolio object 201. Portfolio object 201 responds to signal 804 by deleting the price for selected stock object 506 via link 506, and then displaying the price history for object 506 in windows 614 and 615.

FIG. 9 is a flow diagram of an exemplary buy/sell sequence 900 of program 100 that is activated by clicking on shares button 224 of manager dialog 210 using mouse 112. This causes manager 102 to send a command 907 to computer 108 to cause share dialog 901 to display, as indicated by arrow 903, on screen 115. Concurrently with the display of dialog 901, manager signals portfolio 201 via link 902 to open a link 5 to a selected stock object 911 and to obtain a buy/sell recommendation as well as a quote for Stock D and sales commission from selected stock object 911. These recommendations are previously calculated as described below and stored in stock object 911 during an add sequence 300, a price input sequence 600, a refresh sequence 700 or a record transaction sequence described elsewhere in this specification A number of shares of Stock D is displayed in shares window 912, the current price in price window 906 and the commission fee in window 913. The user may change any of these values disclosed by dialog 901 by sending keyboard signals 914, 915, and 916, respectively. Dialog 901 also includes a buy button 908, a sell button 909, for providing buy and sell commands 906 to portfolio 201, and an exit button 910 for return to dialog 210. Clicking buy button 908, as indicated by arrow 904 or sell button 909 with mouse 112, causes dialog 901 to send a signal 901 to portfolio 201 with the changed values and any buy or sell command. Portfolio 201 responds to signal 901 by changing the shares, price and fee values to those displayed and by calculating any buy or sell and recording the transaction values in stock object 911 to reflect the consummation of a buy or sell transaction in the manner described below. Exit button 910 is pushed to return to dialog 210.

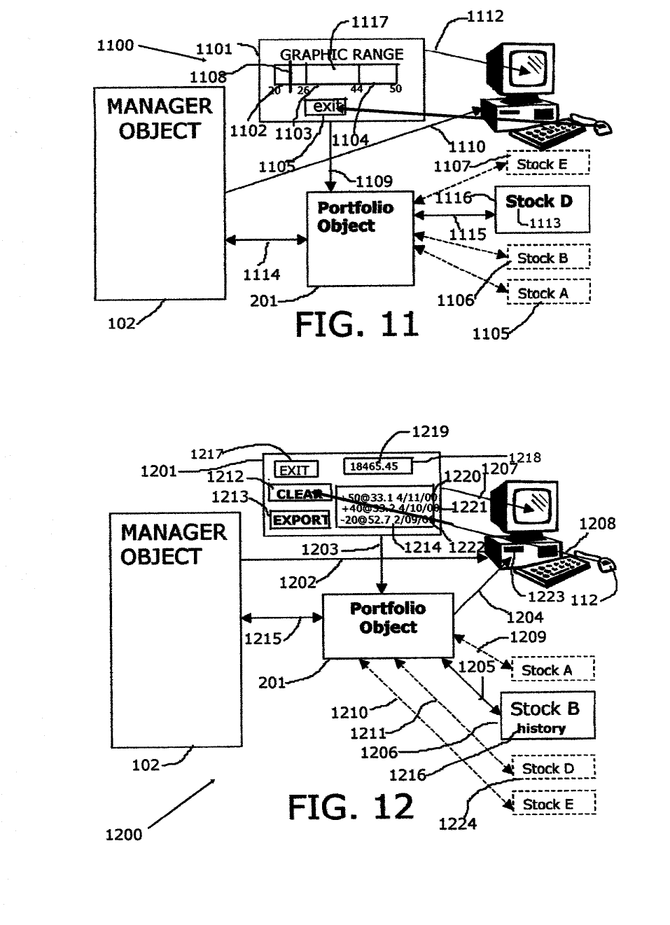

To calculate buy/sell advice, object 102 includes a statistical processor 912 to calculate the mean (“M”) and standard deviation (“SD”) for the daily prices in a price history such as price history 705 of stock object 506. Processor 912 responds to a buy sell advice calculation command from manager 102 by obtaining price data for a given stock such as history 705. Processor 912 uses this price data and calculates M and SD for history 705 according to standard statistical methods and returns M and SD values for history 70 to stock object 506 for storage until requested later. Looking also to FIG. 11, processor 912 also calculated a ninety day high (“NDH”) and establishes NDH as the upper limit 707 for Buy Range 1102 below and sequences, to calculate a sell threshold (“ST”). Processor 912 now sequences to become a Selling Threshold calculator and obtains the M and SD values from each stock object in portfolio 413 and calculates ST=M+(SD×Z) and sets ST as the bottom of buy range 1102 and as the top of hold range 1103. Processor 912 then sequences to become a BT processor. Processor 912 again obtains the M and SD values for stock 409 and calculates BT=M−(SD×Z) and sets BT as the top of hold range 1103 and as the bottom of sell range 1104. Processor 912 then sequences to a ninety day low (“NDL”) calculation. In this capacity, processor 912 obtains the NDL value for stock 506 and sets NDL as the bottom of buy range 1102 and notifies object 102 that the buy/sell range calculations are complete. The process is repeated for each stock in portfolio 413, and then object 102 is signaled that all trading ranges have been set.

FIG. 10 is a flow diagram of an exemplary cash deposit/withdraw sequence 1000 of program 100 that is initiated by activating a cash dialog box 1001 by clicking on cash button 212 in manager dialog 210. Dialog 1001 has a withdraw button 1012, a deposit button 1013, an amount field 1015 and an exit button 1017. An amount to deposit or withdraw is entered in window 1015, as indicated by arrow 1014 using keyboard 107 and then either button 1012 or 1013 is clicked, as indicated by arrow 1004 to activate a deposit or withdrawal, respectively, of the indicated amount of cash. The deposit or withdrawal will be spread throughout portfolio 413 on the next business day, as described below during a cash redistribution process.

In cash redistribution process, and referring to FIGS. 2 and 10, manager object 102 asks each of stock objects 416419 in portfolio 413 for its respective cash request (“CR”) 1018, via link 208 and links 1007-1010) for each of stocks A, B, D and E, as previously determined by object 102 as described above in reference to FIG. 3. Cash request 1018 can be represented as CR=C+CG+(CP×RS), where CR is cash request, C is cash, CG is capital gains, CP is current market price and RS is recommended shares. In response to this request, objects 416-419 provide, via links 1007-1010 their respective RS and CP values to object 102. If a negative CR is provided, or a delete flag (set by the user) is present, the request is set to minus one (which tells the portfolio manager to take all cash from that stock object.) Object 102 totals the CR values of objects 416-419 to get a total cash request (“TCR”) for portfolio 413 and provides the individual RS values, CR values and TCR to manager object 102. Object manager stores these values in a cash request array 1019, in object 1019. Portfolio manager 102 now checks array 1019 for any RS value that is less than some preset min buy quantity, such as for example 10 shares, and adjusts the CR for that stock object to the average CR of the other stock objects, rounding off to the nearest number of shares, or to the preset minimum, whichever is greater. While four stock objects 416-419 are shown for simplicity, portfolio manager 201 manages virtually any number of stocks, and includes a corresponding number of stock objects similar to objects 416-419.

FIG. 11 is a flow diagram of an exemplary trading range viewing sequence 1100 of program 100, which is activated by clicking on the graphic button 217 of manager dialog 210 to cause manager object 102 to send a signal 1110 to computer 108 to display a graphic dialog 1101. Graphic dialog 1101 displays an exemplary horizontal bar graph comprising buy range 1102, a hold range 1103 and a sell range 104, a current price line 1108, and an exit button 1105 for returning to dialog 210. Other displays of these items such as vertical bar graphs, price charts, graphs, tables, etc. could be provided instead if desired. Graphic dialog 1101 signals portfolio object 201 to open a link 1115 to a selected stock object 1116 and then retrieve graphic object 1117, which comprises buy/hold/sell ranges and signals and current price signals 1102-1109 from stock object 1116. Graphic dialog 1101 then displays, as indicated by arrow 1112, graphic 1117 in the form of a trading range. When done observing graphic object 1117, exit button 1105 is clicked with mouse 115 to return to manager dialog 210.

FIG. 12 is a flow diagram showing an exemplary view, export or reset transaction history sequence 1200 of program 100, which is activated by on history button 219 of dialog 210 to cause object 102 to send a signal 1202 to computer 108 to display history dialog 1201. Dialog 1201 has an export button 1213, a clear or reset button 1212 and a data window 1214. Concurrently with display of dialog 1201, manager object 102 signals portfolio 201 via link 1215 to obtain from a selected stock object 1206 a transaction history 1216 and send, as indicated by arrow 1204, that history to computer 108 for display and possible recording. History 1216 can be exported by inserting a suitable recording media such as a floppy disk in drive 1223 and clicking on export button 1213. Alternatively, the history could be sent to a CD, a Zip Disk, or via email or ftp to another computer (not shown). The exemplary export is preferrably a comma-separated-value (CSV) file, as that is the format used by Yahoo and is easily displayed in MS Excel. The program is thus simplified by having CSV for both price history and transaction history. History 1216 may also be exported and cleared by inserting a floppy disk in drive 1223 and clicking clear button 1212. Clicking clear button 1212 causes portfolio 201 to retrieve and send history 1216 as before and then reset history 1216 and to reset a profit/loss value contained in object 1206. If shares of stock B are still held in object 1206, a new transaction with show a “basis” transation with the shares held and the “basis cost” to start off a new transaction history 1206. The profit/loss value is then reset to zero. When the transaction history actions are compete, exit button 1217 is clicked to return to dialog 210.

When exit button 218 is clicked all transactions for the day are recorded and the ratios and advice stored in objects 416-419 for use the following day. This is done by the following process. Object 102 sends a signal to objects 416-419 to record transaction and statistical values. Objects 416-419 check their data to determine whether there has been a transaction for their respective stock. If no, the stock object 1206 for example, signals portfolio object 201 to switch to the next stock object 1224. If yes, object 1206 determines whether the transaction data indicates a buy or a sell. If a buy, object 1206 performs buy transaction updates and if a sell, performs sell updates.

Object 1206 perform a buy update by first obtaining the required data, SH, SP, LB, PSP, LT, FB, CI, SP, Fee, TI, C and FS. Object 1206 then performs the following updates:

Log Transaction

SH=SH+SP

LB=PSP LT=PSP

IF FB=0 then FB=PSP

CI=(PSP×SP)+Fee

TI=TI+CI

C=C−TI

FS=0

Object then records the new values and sends a signal 810 to portfolio 201 to switch to the next stock object 1224.

Object 1206 performs a sell update by first acquiring the required data, SH, SO, LS, PSO, LT, CD, Fee, CI, TI, C, FS, CCG and CG. Object 1206 then performs the following updates:

Log Transaction

SH=SH−SO

LS=PSO LT=PSO

CD=(PSO×SO)−Fee

TI=TI−CD

C=C+CD

If FS=0 then FS=PSO

FB=0

CI=SO×TI/SH

CCG=CD−CI

CG=CG+CCG

and then records the new values in digital storage and sends a signal to portfolio object 201 to process the next stock 1224.

When all stock objects in portfolio 413 have been updated program 100 has completed its daily stock management and is prepared to begin another day and thus closes for the day.

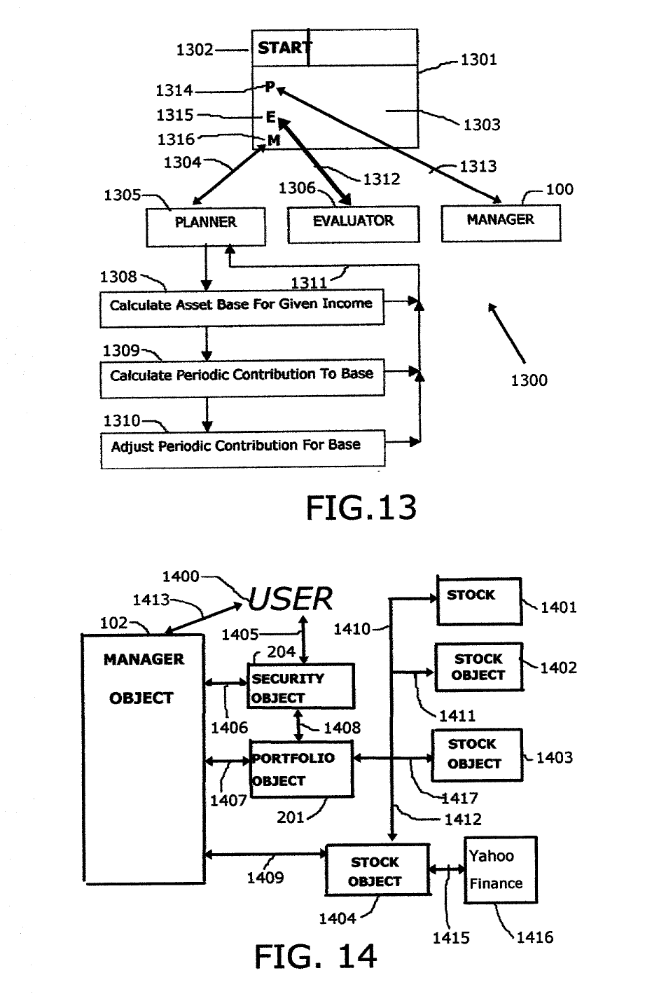

FIG. 13 is a top level flow diagram showing a collection 1300 of three related stock management programs that includes program 100, an evaluator program 1306 and a planner program 1305 and an exemplary set of steps for planner program 1305, which are typically found as icons 1314, 1315, and 1316 on a standard windows desktop 1303 or standard windows start menu 1302 of a screen display of a standard computer monitor 1301. System 1300 takes the form of a program resident in the digital memory of computer 108. Computer 108 can be any digital computer such as a laptop or desktop personal computer using a Microsoft Windows operating system or a Mac OS operating system. As software develops, it is understood that other computer platforms and operating systems may become available and it is envisioned that the exemplary program would be run on such platforms and systems with updates and modifications to allow adaptation to such platforms and systems. Clicking on icons Exemplary planner 1305 is used to perform 3 steps. First planner 1305 can calculate the asset base needed for a given income, given appropriate values by the user in step 1308. Second planner 1305 can calculate a periodic contribution to the asset base needed in step 1309. Third planner 1305 can adjust the periodic contribution for base in view of different conditions in step 1310. Planner can have any number of other standard calculations, such as amortizations, interest rates, etc. without departing from the scope of the invention. Due to the continuing rapid technological advances in personal computers, it will suffice to note that programs 1305, 1306 and 100 can run in real-time with nearly instantaneous results being possible, subject to the limitations of time required for actual investment buys and sells.

FIG. 14 is a flow diagram showing the overall relationship of the objects in the exemplary stock management program 100 of FIGS. 1-12. Program 100 comprises a user interface 1400, a manager object 102, a security object 204, a portfolio object 201, and a plurality of stock objects 1401, 1402, 1403 and 1404. The user interface 1400, which is typically computer 108, first establishes a link 1405 with security object 204, for registration sequence 101 and/or logon sequence 200. Once logon occurs, links 1406, 1407 and 1408 are established for the intial stock additions and cash entries as in sequences 300, and then link 1413 is opened to allow user interaction with manager 102 via dialog 210. Manager 102 then opens either direct links 1409 to stock objects 1404 or indirect links 1410, 1411, 1417 and 1412 through portfolio object 201 to objects 1401, 1402, 1403 and 1404 so that sequences 400, 500, 600, 700, 800, 900, 1000, 1100 and 1200 can be conducted. As appropriate an internet connection 1415 is established to a stock price database 1416 such as Yahoo! Finance for sequences 300, 600 and 700.

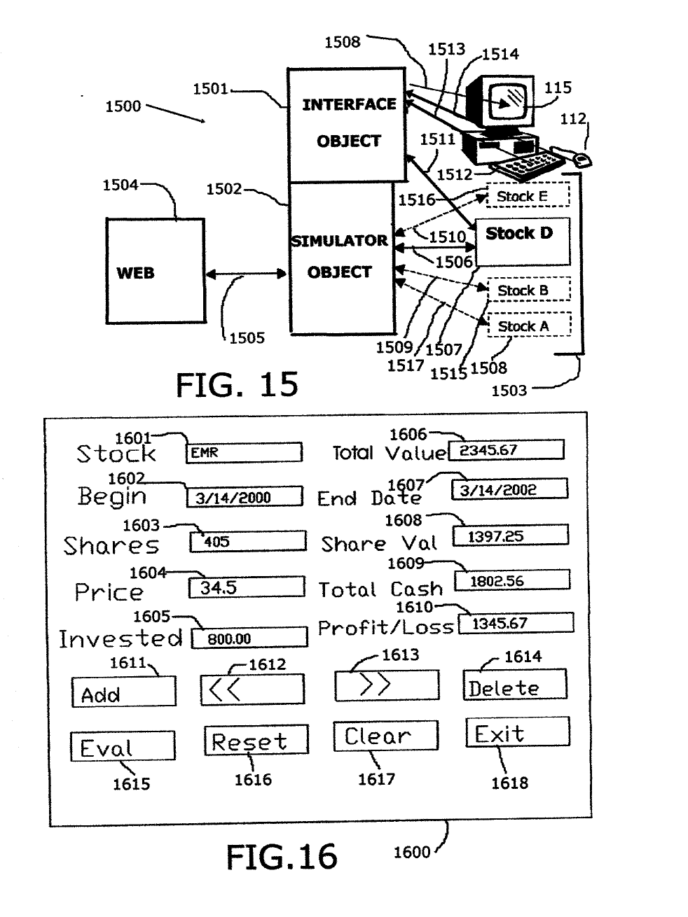

FIG. 15 is a block diagram of an exemplary evaluator program 1500 for evaluating the expected performance of a portfolio 1503 of stock objects 1516, 1507, 1515 and 1508 for the purpose of assisting a user in selecting stocks that appear to historically perform well in the investment logic of manager program 100. Evaluator program 1500 includes an interface object 1501, a simulator object 1502, and stock objects 1516, 1517, 1507 and 1508. The user will also need a computer 108 with a mouse 112 and keyboard 1512 so screen 115 can receive display signals 1508 to display the dialog shown below in FIG. 16 and the user can provide commands. The user also needs an internet connection 1505 so price history can be obtained from a web-based database. Exemplary evaluator 15000 is without a logon screen since the information only resides in RAM and is not saved to disk once evaluated. If it is desired to save the evaluations, a save routine could be added. Interface object 1501 controls the interaction with the user while simulator object 1502 obtains the data, calculates the buys and sells, conducts the buys and sells, calculates the results and provides the results to the interface object for display to the user as indicated by arrow 1508 Object 1501 establishes a link 1511 to a selected stock 1507 from portfolio 1503 as needed to modify the criteria for recalculation. Program 1500 can be run over and over and modified as often as desired while running to evaluate different mixes of stock. Program 1500 runs the same standard deviations, cash redistribution, buy ratios, sell ratios, buy signals, sell signals, as program 100, but assumes that the user accepts immediately any buy or sell recommendation both as to timing and number of shares. Program 1500 can be run, edited, rerun, and re-edited as desired to develop a desired mix of stocks in a portfolio for use in program 100. Program 1500 is a separate program application, since it would likely only be run occasionally and generally at the early stages of investment during which stocks are being selected for investment. It might also be used to see what would have happened if the user had picked different stocks for investment rather than the ones in portfolio 413. Once a desired mix is found, evaluator program 1500 is exited and, the selection of stocks for manager 102 can be more knowledgably made.

FIG. 16 is a dialog 1600 that program 1500 causes to be displayed in program 1500. There are 10 data windows 1601-1610 for data as labeled and eight buttons 1611-1618 for commands as labeled, although other numbers of windows and buttons could be used as desired for less or more information and less or more commands. The stock symbol and the beginning and ending date need to be entered or the default value (two years period ending with the current dated) can be chosen. The exemplary program 1500 assumes $1000 cash per stock to start. The selection of $1000 makes it easier to figure and visualize profits and losses as each dollar is one-tenth of a percent of the initial cash for a stock. The values for cash will be quite different once the program is run, because cash is redistributed for each day of the evaluation period, so for a 90 day typical evaluation period, there will be 90 cash redistributions. Because of this redistribution, there is no need to enter cash for each stock. The results are displayed in windows 1601-1610. The results shown in FIG. 16 are purely fictional placeholders.

Program 100 is a java script program so it can be platform independent. The program is an object-based program. Other programming languages could be used provided the basic logic is similar to that shown. Program 100 performs a process for managing a portfolio of investments having a market price. In one exemplary embodiment, the process comprises the steps of (a) storing ownership quantity data for the investments and overall cash quantity data in a computer memory; (b) assigning a portion of said cash quantity to each of a plurality of said investments in said portfolio; (c) obtaining market price data for each of said investments in said portfolio; (d) statistically generating buy and sell ratios and buy and sell ranges for a plurality of said investments in said portfolio; (e) redistributing based on said ratios said cash among said plurality of investments; (f) generating buy or hold or sell advice for each of said plurality of investments; (g) recalculating, in response to a signal indicative of user acceptance of said advice for any one of said plurality of investments, said ownership quantity, overall cash quantity and portions for the investments based on said market price data in a simulated buy or sell according to said accepted advice, and (h) recording said recalculated data for each of the investments in the portfolio.

In exemplary program 100 a lower limit of said buy range for at least one of said investments is a ninety-day low value of daily market prices for said investment. In exemplary program 100, a “buy threshold” upper limit of said buy range for each of the investments is set according to a formula BT=M−(SD×Z), where BT=buy threshold, M=mean of values of the market price of the investment and Z is a confidence level multiplier of the standard deviation and said buy thresholds are stored in an investment analyzer module for use in generating said buy range. Also, in program 100 said buy range for each of the investments is set as the range between said ninety day low on the bottom and said buy threshold on the top. In exemplary program 100 a “buy threshold” upper limit or for each of the investments is set according to a formula BT=M−(SD×Z), where BT=buy threshold, M=mean of values of the market price of the investment and Z is a confidence level multiplier of the standard deviation and said buy thresholds are stored in an investment analyzer module for use in generating said buy range. In exemplary program 100 an upper limit of said sell range for at least one of said investments is a ninety day high value of daily market prices for said investment. In exemplary program 100, a “sell threshold” lower limit or for said sell range is set according to the formula ST=M+(SD×Z), where ST=sell threshold, M=mean of value of the market price of the investment and said buy thresholds are stored in an investment analyzer module for use in generating said sell advice. Further, in exemplary program 100, said sell range for each of the investments is set as the range between said ninety day low on the bottom and the buy threshold on the top. In program 100 a lower limit or “sell threshold” for said sell range is set according to the formula ST=M+(SD×Z), where ST=sell threshold, M=mean of value of the market price of the investment and said buy thresholds are stored in an investment analyzer module for use in generating said sell advice.

In exemplary program 100 the lower limit of said buy range for at least one of said investments is a ninety-day low value of daily market prices for said investment and an upper limit of said sell range for at least one of said investments is a ninety-day high value of daily market prices for said investment. Also, in exemplary program 100, a “buy threshold” upper limit of said buy range for each of the investments is set according to a formula BT=M−(SD×Z), where BT=buy threshold, M=mean of values of the market price of the investment and Z is a confidence level multiplier of the standard deviation and said buy thresholds are stored in an investment analyzer module for use in generating said buy range. In program 100, said buy range for each of the investments is set as the range between said ninety day low on the bottom and the buy threshold on the top and said sell range for each of the investments is set as the range between said ninety day low on the bottom and the buy threshold on the top.

In program 100, a buy signal is generated for one of the investments if the current price of that investment is within said buy range and is lower than the last buy price of that investment since the last sale of that investment and a buy signal is also generated for an investment if the current price of the investment is within said buy range and there has either been no buy of the investment or no buy of the investment since the last sale of the investment. Similarly, in program 100 a sell signal is generated for one of the investments if the current price of the investment is within said sell range and is higher than the last sell price of the investment since the last buy of the investment and a buy signal is also generated for one of the investments if the current price of the investment is within said buy range and there has either been no prior purchase of the investment or no purchase since the last sale of the investment.

In exemplary program 100 a recommended number of shares are set for any one of the investments for which a buy signal or sell signal respectively exists, by multiplying an amount of cash assigned to the investment times a buy ratio or sell ratio respectively, for the investment. The buy ratio for one of the investment increases for a subsequent consecutive day, if any, during which a buy signal exists for said one investment and said sell ration increases for one of the investments for a successive consecutive day, if any, during which a sell signal exists for said one of the investments, respectively. The buy ration can either increase in equal or non-equal increments only to a maximum value of about 0.90 so that there is always some cash available to be redistributed.

In exemplary program 100, the cash redistribution is at least partially in proportion to the magnitude of the requested shares of each investment. For example, a sell signal is generated for one of the investments if the current price of that investment is within said buy range and is lower than the last price at which that investment was purchased and a sell signal is also generated for said one of said investments if the current price of that investment is within said sell range and there has either been no prior sale of said vestment or no sale since the last buy of said investment.

In program 100 a buy signal is generated for any one of the investments if the current price of said one investment is within said buy range and is lower than the last price at which said one investment was purchased and if the current price of said one investment is within said sell range and is higher than the last price at which said one investment was sold. Further, a recommended number of shares are set for any one of said investments for which a buy signal or sell signal exists, by multiplying an amount of cash assigned to said one investment tines a buy ratio or sell ratio, respectively and the cash redistribution is at least part in proportion to the magnitude of said requested shares of each investment.

In program 100, a capital gain record is calculated and recorded during said recalculation step in response to any simulated buy for each of the investments bought and a total of said capital gains is stored in the memory 109 computer 108.

In a second exemplary investment program the method of operation includes the steps of (a) selecting a plurality of variable price investments to be managed, (b) obtaining historical price data for each of said plurality of investments in the portfolio over a certain number of days; (c) statistically evaluating said historical price data to generate standard deviation of said price data for each of said investments; (d) calculating buy and sell threshold prices for each of said plurality of said investments in said portfolio by applying a confidence level to determine a desired probability that said threshold prices are lower and higher, respectively, than some desired percentage of prices in said historical data for each of said plurality of investments; (e) establishing as an upper and lower limit a historical high and historical low over a selected period: (f) generating a buy signal for any of said plurality of investments that is below said buy threshold, above said lower lint and, if there has been any prior buy of said investment since a last sell of said investment, below the price of said prior buy; (g) generating a sell signal for any of said plurality of investments that is above said sell threshold, below said upper limit and, if there has been any prior sale of said investment since a last buy of said investment, above the price of said prior sale, (f) recalculating, in response to a signal indicative of user acceptance of said advice for any one of said plurality of investments, said ownership quantity, overall cash quantity and portions for the investments based on said market price data in a simulated buy or sell according to said accepted advice, and (h) recording said recalculated data for each of the investments in the portfolio.

The above exemplary embodiment describes the best mode of making and using the invention known at this time. The exemplary embodiment is provided in satisfaction of the statutory duties of best mode disclosure and enablement. However, there are numerous other embodiments possible, and compliance with the statutory requirements for best mode and enablement should not be misunderstood to mean that only the best mode is covered, when that is not intended. For example, the system is described as operable on a PC or laptop using Windows. The system is logic based, so the operating system is a variable that could be modified by a routine programmer to fit Mac or Linux. Similarly, the planner module 101 and evaluation module 102 would be omitted for most users, as the users typically have their stocks already selected and mainly just want to manage those stocks better using the sophisticated procedures of this program. The invention is limited by the prior, but not the above exemplary embodiment, and it is applicant's intention to encompass all in the above disclosure that is not excluded by virtue of 35 USC 102-103 No dedication of any disclosed or undisclosed portion of the invention is intended. The fill breadth of equivalents is sought. No equivalents are intended to be excluded and none should be excluded except as required by the prior art.

What is claimed is:

1. A method of managing a portfolio of investments having a market price, comprising the steps of
a) storing ownership quantity data for the investments and overall cash quantity data in a computer memory;
b) assigning a portion of said cash quantity to each of a plurality of said investments in said portfolio
c) obtaining market price data for each of said investments in said portfolio;
d) statistically generating buy and sell ratios and buy and sell ranges for a plurality of said investments in said portfolio;
e) redistributing based on said ratios said cash among said plurality of investments;
f) generating buy or hold or sell advice for each of said plurality of investments; and
g) recalculating, in response to a signal indicative of user acceptance of said advice for any one of said plurality of investments, said ownership quantity, overall cash quantity and portions for the investments based on said market price data in a simulated buy or sell according to said accepted advice, and
h) recording said recalculated data for each of the investments in the portfolio.

2. A method in accordance with claim 1 wherein a lower limit of said buy range for at least one of said investments is a ninety day low value of daily market prices for said investment.

3. A method in accordance with claim 2 wherein a “buy threshold” upper limit of said buy range for each of the investments is set according to a formula BT=M−(SD×Z), where BT=buy threshold, M=mean of values of the market price of the investment and Z is a confidence level multiplier of the standard deviation and said buy thresholds are stored in an investment analyzer module for use in generating said buy range.

4. A method in accordance with claim 3 wherein said buy range for each of the investments is set as the range between said ninety day low on the bottom and said buy threshold on the top.

5. A method in accordance with claim 1 wherein a “buy threshold” upper lit or for each of the investments is set according to a formula BT=M−(SD×Z), where BT=buy threshold, M=mean of values of the market price of the investment and Z is a confidence level multiplier of the standard deviation and said buy thresholds are stored in an investment analyzer module for use in generating said buy range.

6. A method in accordance with claim 1 wherein an upper limit of said sell range for at least one of said investments is a ninety day high value of daily market prices for said investment.

7. A method in accordance with claim 6 wherein a “sell threshold” lower limit or for said sell range is set according to the formula ST=M+(SD×Z), where ST=sell threshold, M=mean of value of the market price of the investment and said buy thresholds are stored in an vestment analyzer module for use in generating said sell advice.

8. A method in accordance with claim 7 wherein said sell range for each of the investments is set as the range between said ninety day low on the bottom and the buy threshold on the top

9. A method in accordance with claim 1 wherein a lower limit or “sell threshold” for said sell range is set according to the formula ST=M+(SD×Z), where ST=sell threshold, M=mean of value of the market price of the investment and said buy thresholds are stored in an investment analyzer module for use in generating said sell advice.

10. A method in accordance with claim 9 wherein a lower limit of said buy range for at least one of said investments is a ninety day low value of daily market prices for said investment.

11. A method in accordance with claim 10 wherein an upper limit of said sell range for at least one of said investments is a ninety day high value of daily market prices for said investment.

12. A method in accordance with claim 11 wherein a “buy threshold” upper limit of said buy range for each of the investments is set according to a formula BT=M−(SD×Z), where BT-buy threshold, M=mean of values of the market price of the investment and Z is a confidence level multiplier of the standard deviation and said buy thresholds are stored in an investment analyzer module for use in generating said buy range.

13. A method in accordance with claim 12 wherein said buy range for each of the investments is set as the range between said ninety day low on the bottom and the buy threshold on the top.

14. A method in accordance with claim 13 wherein said sell range for each of the investments is set as the range between said ninety day low on the bottom and the buy threshold on the top

15. A method in accordance with claim 14 wherein a buy signal is generated for one of the investments if the current price of that investment is within said buy range and is lower than the last buy price of that investment since the last sale of that investment.

16. A method in accordance with claim 15 wherein a buy signal is also generated for an investment if the current price of the investment is within said buy range and there has either been no buy of the investment or no buy of the investment since the last sale of the investment.

17. A method in accordance with claim 16 wherein a sell signal is generated for one of the investments if the current price of the investment is within said sell range and is higher than the last sell price of the investment since the last buy of the investment.

18. A method in accordance with claim 17 wherein a buy signal is also generated for one of the invests if the current price of the investment is within said buy range and there has either been no prior purchase of the investment or no purchase since the last sale of the investment.

19. A method in accordance with claim 1 wherein a recommended number of shares are set for any one of the investments for which a buy signal or sell signal respectively exists, by multiplying an amount of cash assigned to the investment times a buy ratio or sell ratio, respectively, for the investment.

20. A method in accordance with claim 19 wherein said buy ratio for one of the investment increases for a subsequent consecutive day, if any, during which a buy signal exists for said one investment and said sell ration increases for one of the investments for a successive consecutive day, if any, during which a sell signal exists for said one of the investments, respectively.

21. A method in accordance with claim 20 wherein said ratio increases in equal increments.

22. A method in accordance with claim 20 wherein said ratio increases in non-equal increments.

23. A method in accordance with claim 20 wherein said ratio increases only to a maximum value.

24. A method in accordance with claim 23 wherein said maximum value is about 0.90.

25. A method in accordance with claim 19 wherein said cash redistribution is at least partially in proportion to the magnitude of said requested shares of each investment.

26. A method in accordance with claim 15 wherein a sell signal is generated for one of the investments if the current price of that investment is within said buy range and is lower than the last price at which that investment was purchased

27. A method in accordance with claim 15 wherein a sell signal is also generated for said one of said investments if the current price of that investment is within said sell range and there has either been no prior sale of said investment or no sale since the last buy of said investment.

28. A method in accordance with claim 1 wherein a buy signal is generated for any one of the investments if the current price of said one investment is within said buy range and is lower than the last price at which said one investment was purchased and wherein a sell signal is generated for any one of the investments if the current price of said one investment is within said sell range and is higher than the last price at which said one investment was sold.

29. A method in accordance with claim 28 wherein a recommended number of shares are set for any one of said investments for which a buy signal or sell signal exists, by multiplying an amount of cash assigned to said one investment times a buy ratio or sell ratio, respectively.

30. A method in accordance with claim 29 wherein said cash redistribution is at least partially in proportion to the magnitude of said requested shares of each investment.

31. A method in accordance with claim 1 wherein a capital gain record is calculated and recorded during said recalculation on step in response to any said simulated buy for each of the investments sold.

32. A method in accordance with claim 31 wherein a total of said capital gains is stored in said computer memory for each of said investments.

33. A method of managing a portfolio of investments having a market price, comprising the steps of
a) selecting a plurality of variable price investments to be managed;
b) obtaining historical price data for each of said plurality of investments in the portfolio over a certain number of days;
c) statistically evaluating said historical price data to generate standard deviation of said price data for each of said investments;
d) calculating buy and sell threshold prices for each of said plurality of said investments in said portfolio by applying a confidence level to determine a desired probability that said threshold prices are lower and higher, respectively, than some desired percentage of prices in said historical data for each of said plurality of investments;
e) establishing as an upper and lower limit a historical high and historical low over a selected period
f) generating a buy signal for any of said plurality of investments that is below said buy threshold, above said lower limit and, if there has been any prior buy of said investment since a last sell of said investment, below the price of said prior buy;
g) generating a sell signal for any of said plurality of investments that is above said sell threshold, below said upper limit and, if there has been any prior sale of said investment since a last buy of said investment, above the price of said prior sale;
h) redistributing a portion of said available cash to each stock having a buy signal in accordance with a preset ration;
j) recalculating, in response to a signal indicative of user acceptance of said buy and sell signals for any one of said plurality of investments, said ownership quantity, overall cash quantity and portions for the investments based on said market price data in a simulated buy or sell according to said accepted advice; and
k) recording said recalculated data for each of the investments in the portfolio.

34. A method in accordance with claim 33, wherein said price data is obtained via a global information network and said buy and sell signals are calculated virtually immediately and said recalculations are performed in real-time.

35. A method in accordance with claim 33 further comprising a computerized evaluation mode where the program can be automatically and interactively simulated in seconds for simulated investments over a selected period of days to evaluate historical performance of said investments in said method.
